(19) United States
(12) Patent Application Publication
(10) Pub. No.: US 2019/0171992 A1
(43) Pub. Date: Jun. 6, 2019

(54) ABILITY EVALUATION SYSTEM

(71) Applicant: JTEKT CORPORATION, Osaka-shi (JP)

(72) Inventors: Kazuma SUZUKI, Kariya-shi (JP); Guangyu Zhu, Kariya-shi (JP); Teruo Okumura, Toyohashi-shi (JP); Tomotaka Hanji, Nishio-shi (JP)

(73) Assignee: JTEKT CORPORATION, Osaka-shi (JP)

(21) Appl. No.: 16/207,386

(22) Filed: Dec. 3, 2018

(30) Foreign Application Priority Data
Dec. 5, 2017 (JP) 2017-233118

(51) Int. Cl. G06Q 10/06; G06F 16/9035

(52) U.S. Cl. CPC G06Q 10/06395; G06F 16/9035; G06Q 10/06398

(57) ABSTRACT

An ability evaluation system includes an input device configured to input improvement proposal information including at least one of a problematic issue, a solution to the issue, and a method for implementing the solution to the issue, an improvement proposal storage device configured to store the improvement proposal information, an access device configured to allow at least another person different from a proponent to access the stored improvement proposal information, an access information storage device configured to store first access information on the other person when the other person accesses the improvement proposal information, and an improvement ability calculation device configured to calculate a proponent's improvement ability based on the first access information.

### INCORPORATION BY REFERENCE

The disclosure of Japanese Patent Application No. 2017-233118 filed on Dec. 5, 2017 including the specification, drawings and abstract, is incorporated herein by reference in its entirety.

### BACKGROUND OF THE INVENTION

### 1. Field of the Invention

The present invention relates to an ability evaluation system.

### 2. Description of the Related Art

In companies, employees carry out improvement activities every day. For example, the improvement activity refers to an activity to find a problematic issue, plan a solution to address the issue, and implement the solution. The employee's improvement activity may be used for evaluation of an employee's ability. In general, the evaluation of the employee's ability based on the improvement activity is subjective evaluation carried out by a supervisor.

Japanese Patent No. 5916460 (JP 5916460 B) describes a management system in which employees' ideas, proposals, and the like can be registered, viewed, and revised. The system is configured to manage a series of operations including registration of an employee's idea, creation of a proposal based on the idea, request for circulation of the proposal, circulation of the proposal among persons concerned, reception of the proposal at a receiving department, and visualization and changing of a circulation route and a circulation status.

Japanese Patent No. 5136026 (JP 5136026 B) describes that, when a trouble that needs to be solved is received and a plan for measures against the trouble is input, a plurality of cases where the trouble is solved by taking the input measures and effects of the measures are displayed in a list. Thus, anyone can easily determine an optimum measure by taking some measures tentatively and comparing the degrees of effects with reference to the displayed list.

As described above, the employee's ability based on the improvement activity is evaluated subjectively by the supervisor. The evaluation by the supervisor is an important factor, but is not appropriate alone.

### SUMMARY OF THE INVENTION

It is one object of the present invention to provide an ability evaluation system in which an improvement ability can be evaluated more appropriately.

An ability evaluation system according to one aspect of the present invention includes:

an input device configured to input improvement proposal information provided by a proponent, the improvement proposal information including at least one of a problematic issue, a solution to the issue, and a method for implementing the solution to the issue;

an improvement proposal storage device configured to store the input improvement proposal information;

an access device configured to allow at least another person different from the proponent to access the improvement proposal information stored in the improvement proposal storage device;

an access information storage device configured to store first access information on the other person when the other person accesses the improvement proposal information with the access device; and

an improvement ability calculation device configured to calculate, based on the first access information, an improvement ability of the proponent who provides the improvement proposal information.

When the proponent creates the improvement proposal information, the improvement proposal information is input with the input device to store the improvement proposal information in the improvement proposal storage device. That is, the improvement proposal storage device can store a plurality of pieces of improvement proposal information. For example, the improvement proposal storage device stores a plurality of pieces of improvement proposal information provided by one proponent, or pieces of improvement proposal information provided by a plurality of proponents.

Since the ability evaluation system includes the access device, the other person can access the improvement proposal information stored in the improvement proposal storage device. The other person refers to a person different from the proponent who provides the improvement proposal information. When the other person accesses the improvement proposal information, the first access information that is information on the access from the other person is stored in the access information storage device. Based on the first access information, the improvement ability calculation device calculates the improvement ability of the proponent.

The fact that the other person accesses the improvement proposal information leads to a possibility that the improvement proposal information is useful to the other person, attracts attention of the other person, or arouses interest of the other person. Therefore, the improvement ability calculation device calculates the improvement ability of the proponent based on the first access information related to the access from the other person. Thus, the improvement ability of the proponent can be evaluated more appropriately because the evaluation by the other person different from a supervisor can be taken into consideration.

### BRIEF DESCRIPTION OF THE DRAWINGS

The foregoing and further features and advantages of the invention will become apparent from the following description of example embodiments with reference to the accompanying drawings, wherein like numerals are used to represent like elements and wherein:

FIG. 1 is a functional block diagram of an ability evaluation system;

FIG. 2 is a diagram illustrating improvement proposal information;

FIG. 3 is a diagram illustrating a classification associated with the improvement proposal information;

FIG. 4 is a diagram illustrating a supervisor's evaluation for the improvement proposal information;

FIG. 5 is a diagram illustrating general improvement proposal information stored in an improvement proposal storage device;

FIG. 6 is a diagram illustrating access information stored in an access information storage device;

FIG. 7 is a diagram illustrating ability elements related to an improvement ability to be calculated by an improvement ability calculation device and data related to the ability elements;

FIG. 8 is a diagram illustrating contents to be presented by a presentation device; and

FIG. 9 is a diagram illustrating another form of the presentation contents of the improvement ability to be presented by the presentation device.

### DETAILED DESCRIPTION OF EMBODIMENTS

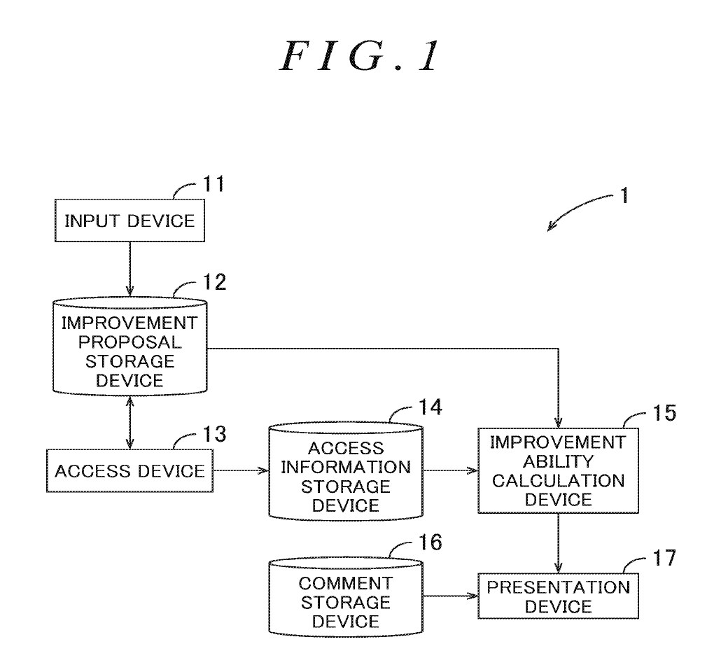

The configuration of an ability evaluation system 1 is described with reference to FIG. 1 to FIG. 9. For example, the ability evaluation system 1 is targeted at operators in a production factory, and evaluates operators' improvement abilities based on their improvement proposals. The ability evaluation system 1 may be targeted not only at the operators in the production factory but also at persons involved in a wide variety of business fields. The following description is directed to the exemplary case where the ability evaluation system 1 is targeted at the operators in the production factory.

Based on contents of an improvement proposal provided by a proponent, the ability evaluation system 1 evaluates a proponent's improvement ability. The proponent's improvement ability is evaluated in consideration of, for example, evaluation of the individual contents of the improvement proposal by a supervisor, evaluation of the individual contents of the improvement proposal by another person different from the supervisor, and a proponent's willingness for improvement.

As illustrated in FIG. 1, the ability evaluation system 1 includes an input device 11, an improvement proposal storage device 12, an access device 13, an access information storage device 14, an improvement ability calculation device 15, a comment storage device 16, and a presentation device 17.

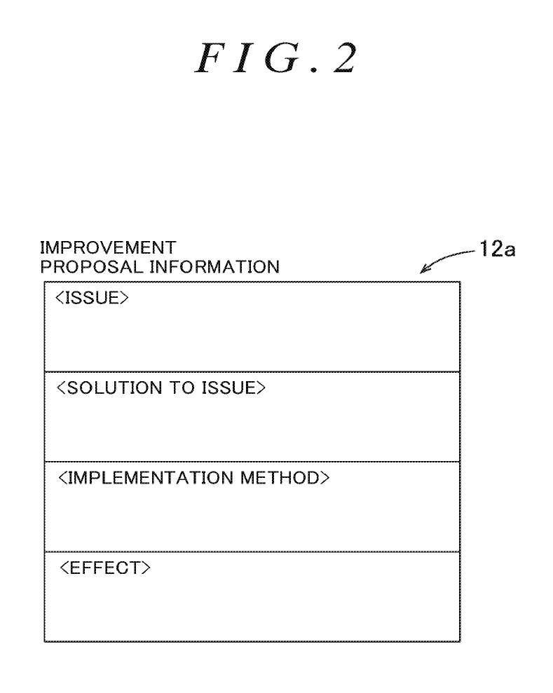

As illustrated in FIG. 2, proponent's improvement proposal information 12a is input with the input device 11. Examples of the input device 11 include a stationary terminal and a mobile terminal. For example, the input device 11 is a terminal that can be used by members who belong to an organization such as a company or a group. The input device 11 may be provided to each member, or may be shared by a plurality of members. The input device 11 is a terminal that constitutes a network. The network may be a wired or wireless network.

An application is installed in the input device 11 so that the improvement proposal information 12a can be input. With the input device 11, the proponent inputs information such as text data, image data, or video data as the improvement proposal information 12a.

As illustrated in FIG. 2, the improvement proposal information 12a includes, for example, a problematic issue, a solution to the issue, and a method for implementing the solution to the issue. At least one of the issue, the solution, and the implementation method includes text data. Thus, a text search can be performed. If an image recognition function or a video recognition function is provided, only image data or video data may be included instead of the text data.

The improvement proposal information 12a need not be itemized as illustrated in FIG. 2. For example, the improvement proposal information 12a need not be itemized. When the improvement proposal information 12a is itemized, the itemization method is not limited to the above, but may be such that the issue and the solution are included but the implementation method is not included. In this case, contents corresponding to the implementation method may be input in, for example, the item “solution”. The improvement proposal information 12a may include information related to an improvement proposal as well as the issue, the solution, and the implementation method.

With the input device 11, the proponent may input all of the issue, the solution, and the implementation method as the improvement proposal information 12a, or may input only one or two selected items as the improvement proposal information 12a. For example, the proponent may input, with the input device 11, only the issue at a certain timing and the solution to the issue and the implementation method at a subsequent timing. Regarding an issue input by another person, another proponent may input a solution to the issue and an implementation method. The proponent may input other information that is not itemized as the issue, the solution, and the implementation method.

As illustrated in FIG. 2, the improvement proposal information 12a further includes an effect obtained when the implementation method is executed. Examples of the effect may include a qualitative effect, a quantitative effect, and a corresponding amount of effect money.

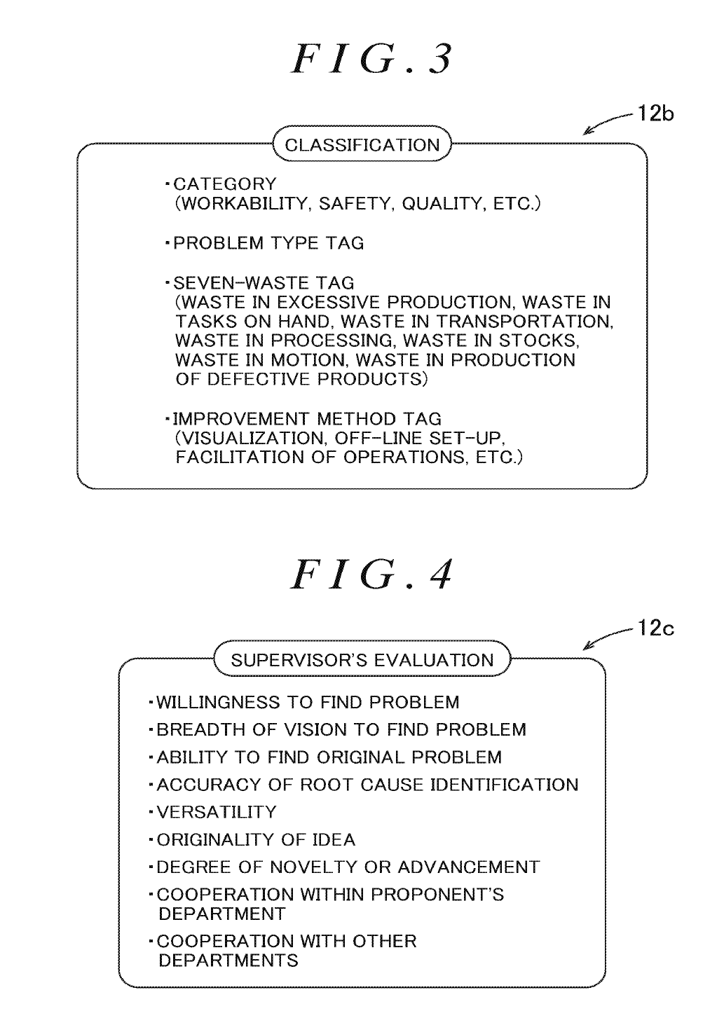

When the improvement proposal information 12a is classified from a plurality of viewpoints as illustrated in FIG. 3, a corresponding classification 12b can be input with the input device 11. The classification 12b is input by the proponent who inputs the improvement proposal information 12a. For example, the classification 12b includes items illustrated in FIG. 3. That is, the classification is roughly divided into a category of improvement, a problem type tag, a seven-waste tag, and an improvement method tag. The classification 12b is not limited to the items illustrated in FIG. 3, but may be divided into various items.

For example, the category is divided into workability, safety, and quality. For example, the problem type tag is divided into operation difficulty, the number of operation steps, a set-up time, and an unnecessary walk distance. The seven-waste tag is divided into a waste in excessive production, a waste in tasks on hand, a waste in transportation, a waste in processing, a waste in stocks, a waste in motion, and a waste in production of defective products. For example, the improvement method tag is divided into visualization, off-line set-up, and facilitation of operations.

For example, the input device 11 is configured such that one or a plurality of items can be selected in each of the category, the problem type tag, the seven-waste tag, and the improvement method tag by using checkboxes as one element of a graphical user interface. For example, if the seven wastes corresponding to the improvement proposal information 12a are related to the waste in excessive production and the waste in stocks, checkmarks may be put to the waste in excessive production and the waste in stocks in the seven-waste tag.

A supervisor's evaluation 12c can be input with the input device 11. The supervisor's evaluation 12c is provided by the supervisor for the improvement proposal information 12a. The supervisor is a person authorized to supervise the proponent who provides the improvement proposal information 12a. For example, the supervisor is a chief of the department to which the proponent belongs. The supervisor may input the supervisor's evaluation 12c with the input device 11, or the proponent who receives the supervisor's evaluation 12c may input the supervisor's evaluation 12c with the input device 11.

For example, as illustrated in FIG. 4, the supervisor's evaluation 12c includes a willingness to find a problem, a breadth of vision to find a problem, an ability to find an original problem, an accuracy of root cause identification, versatility, originality of the idea, the degree of novelty or advancement, cooperation within a proponent's department, and cooperation with other departments. For example, the supervisor's evaluation 12c is represented by an evaluation point at a plurality of grades (for example, five grades). As the supervisor's evaluation 12c, some of the evaluation items described above may be used instead of using all the evaluation items described above. The supervisor's evaluation 12c is not limited to the evaluation items of FIG. 4, but various evaluation items may be employed.

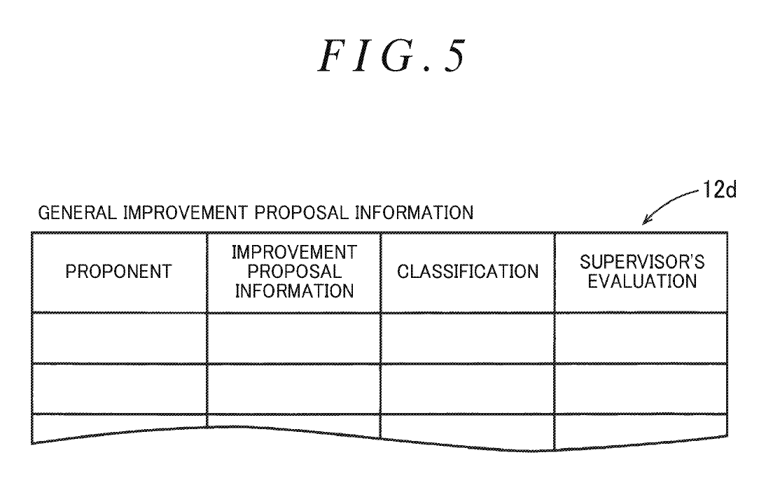

As illustrated in FIG. 5, the improvement proposal storage device 12 stores general improvement proposal information 12d including the proponent, the improvement proposal information 12a, the classification 12b, and the supervisor's evaluation 12c that are input with the input device 11. As the general improvement proposal information 12d, the improvement proposal storage device 12 stores the proponent, the classification 12b, and the supervisor's evaluation 12c in association with the improvement proposal information 12a. For convenience, FIG. 5 illustrates the improvement proposal information 12a, the classification 12b, and the supervisor's evaluation 12c in a table format, but the improvement proposal information 12a, the classification 12b, and the supervisor's evaluation 12c include the information illustrated in FIG. 2 to FIG. 4.

The access device 13 is connected to the improvement proposal storage device 12 by establishing a network between the access device 13 and the improvement proposal storage device 12. The access device 13 allows access to the general improvement proposal information 12d stored in the improvement proposal storage device 12. For example, the access device 13 can be used by a person who can use the input device 11. For example, if a proponent who belongs to a certain department can use the input device 11, this proponent can use the access device 13, another person different from the proponent can use the access device 13, and a supervisor of the proponent can use the access device 13.

The other person refers to a person different from a proponent who provides improvement proposal information. The other person different from the proponent includes a person who belongs to the same department as that of the proponent, and a person who belongs to another department different from the department to which the proponent belongs. The access device 13 may be used by a person other than the person who can use the input device 11. By providing the access device 13, the other person can easily access the improvement proposal information 12a stored in the improvement proposal storage device 12.

Similarly to the input device 11, examples of the access device 13 include a stationary terminal and a mobile terminal. The access device 13 may double as the input device 11, or may be a device different from the input device 11. An application is installed in the access device 13 so as to allow access to the improvement proposal storage device 12.

The access device 13 is configured to search for desired improvement proposal information 12a by, for example, using text included in the improvement proposal information 12a, using a proponent name, or selecting the classification 12b. The access device 13 allows first access to the improvement proposal information 12a obtained through the search from the other person different from the proponent, second access to the improvement proposal information 12a from the proponent, and third access to the improvement proposal information 12a from the proponent. The first access from the other person includes such actions that (1a) the other person views the proponent's improvement proposal information 12a, (1b) the other person gives a favorable evaluation for the proponent's improvement proposal information 12a, and (1c) when the other person utilizes the proponent's improvement proposal information 12a for an operation of the other person, the other person records the utilization.

The second access from the proponent includes such actions that, when the proponent executes the method for implementing his/her solution, (2a) the proponent records information on the execution, and (2b) the proponent records a completion rate indicating the degree of completion of the execution. The third access from the proponent includes such actions that (3a) the proponent views the improvement proposal information 12a of the other person, (3b) the proponent gives a favorable evaluation for the improvement proposal information 12a of the other person, and (3c) when the proponent utilizes the improvement proposal information 12a of the other person for an operation of the proponent, the proponent records the utilization. That is, the first access and the third access correspond to a reverse relationship between the proponent and the other person.

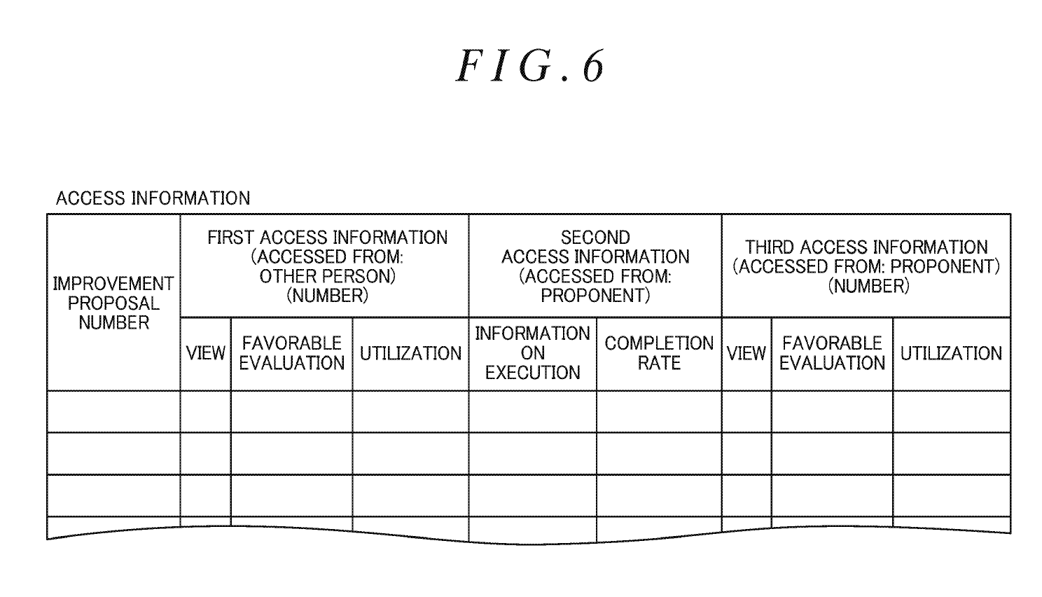

As illustrated in FIG. 6, the access information storage device 14 stores first access information, second access information, and third access information. The first access information is information related to the first access to the proponent's improvement proposal information 12a from the other person with the access device 13. The first access information includes the number of views of the proponent's improvement proposal information by the other person, the number of favorable evaluations for the proponent's improvement proposal information by the other person, and the number of utilizations of the proponent's improvement proposal information by the other person.

The second access information is information related to the second access to the proponent's improvement proposal information 12a from the proponent with the access device 13. The second access information includes the information on the execution by the proponent and the completion rate. The third access information is information related to the third access to the improvement proposal information 12a of the other person from the proponent with the access device 13. The third access information includes the number of views of the improvement proposal information of the other person by the proponent, the number of favorable evaluations for the improvement proposal information of the other person by the proponent, and the number of utilizations of the improvement proposal information of the other person by the proponent.

The improvement ability calculation device 15 calculates an improvement ability of the proponent who provides the improvement proposal information 12a based on the first access information, the second access information, and the third access information that are stored in the access information storage device 14. The improvement ability calculation device 15 calculates the proponent's improvement ability based also on the supervisor's evaluation 12c stored in the improvement proposal storage device 12. The improvement ability calculation device 15 calculates the proponent's improvement ability based also on the number of classifications 12b stored in the improvement proposal storage device 12.

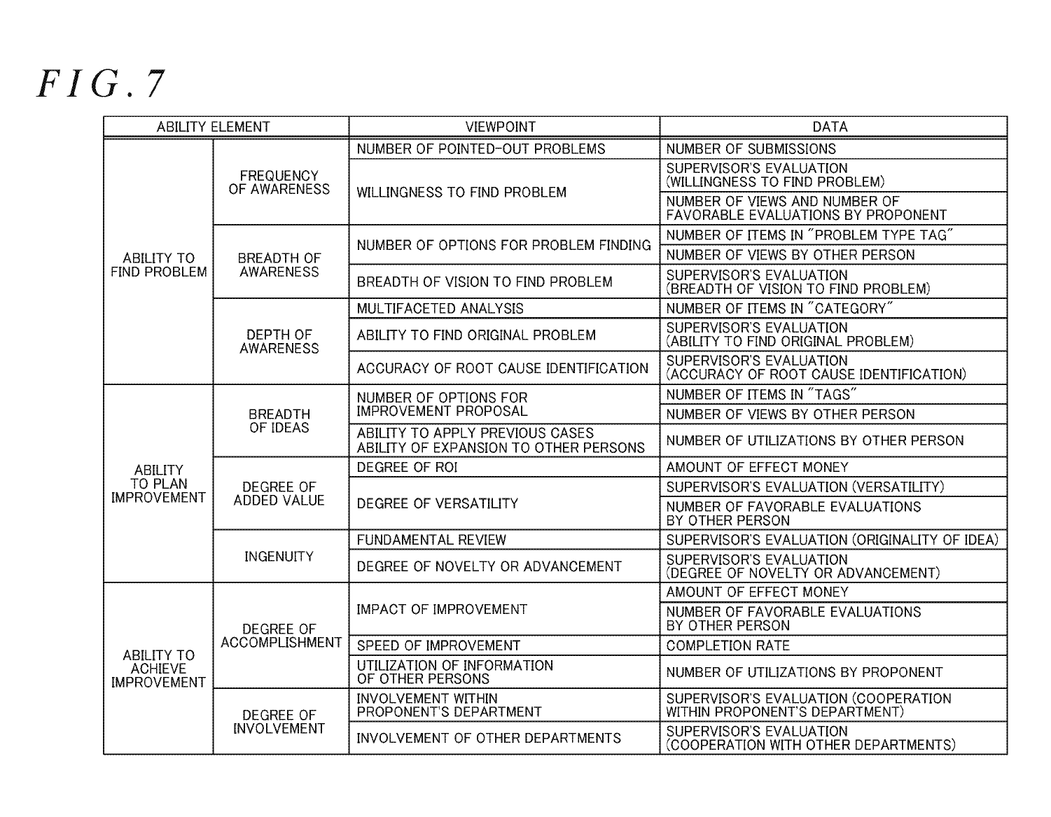

As illustrated in FIG. 7, elements of the improvement ability are roughly divided into an ability to find a problem, an ability to plan improvement, and an ability to achieve improvement. The major elements of the improvement ability may be other elements. The number of major elements of the improvement ability may be determined arbitrarily.

Each major element of the improvement ability is represented by an evaluation point at a plurality of grades (for example, five grades). The evaluation point of each major element of the improvement ability is calculated based on evaluation points related to a plurality of minor elements. Similarly to the major element, each minor element of the improvement ability is represented by an evaluation point at a plurality of grades (for example, five grades). For example, the evaluation point of the major element of the improvement ability is an average of evaluation points related to a plurality of corresponding minor elements. The evaluation point of the major element of the improvement ability may be a value obtained by assigning weights to a plurality of corresponding minor elements and performing calculation based on evaluation points of the minor elements and the weights assigned to the minor elements. Other calculation methods may be applied as well.

For example, each major element of the improvement ability is represented by a plurality of minor elements as follows. The major element “ability to find a problem” is divided into a frequency of awareness, a breadth of awareness, and a depth of awareness as the minor elements of the improvement ability. The major element “ability to plan improvement” is divided into a breadth of ideas, the degree of added value, and originality as the minor elements of the improvement ability. The major element “ability to achieve improvement” is divided into the degree of accomplishment of a method for implementing a solution and the degree of involvement of other persons as the minor elements of the improvement ability. The minor elements of the improvement ability may be other elements. The number of minor elements of the improvement ability may be determined arbitrarily.

The evaluation point of each minor element of the improvement ability is calculated based on evaluation points related to a plurality of viewpoints. Similarly to the major element and the minor element, each viewpoint is represented by an evaluation point at a plurality of grades (for example, five grades). For example, the evaluation point of the minor element of the improvement ability is an average of evaluation points related to a plurality of corresponding viewpoints. The evaluation point of the minor element of the improvement ability may be a value obtained by assigning weights to a plurality of corresponding viewpoints and performing calculation based on evaluation points of the viewpoints and the weights assigned to the viewpoints. Other calculation methods may be applied as well.

The evaluation point related to the frequency of awareness that is one of the minor elements of the improvement ability corresponding to the major element “ability to find a problem” is calculated based on evaluation points of viewpoints related to the number of pointed-out problems and a willingness to find a problem. For example, the evaluation point related to the number of pointed-out problems is calculated based on the number of submissions of improvement proposal information. The evaluation point related to the willingness to find a problem is calculated based on the willingness to find a problem in the supervisor's evaluation 12c, the number of views by the proponent, and the number of favorable evaluations by the proponent. The number of views and the number of favorable evaluations by the proponent are included in the third access information of FIG. 6.

The evaluation point related to the breadth of awareness that is one of the minor elements of the improvement ability is calculated based on evaluation points of viewpoints related to the number of options for problem finding and a breadth of vision to find a problem. The evaluation point related to the number of options for problem finding is calculated based on the number of items in the problem type tag and the number of views by the other person. The number of views by the other person is included in the first access information of FIG. 6. The evaluation point related to the breadth of vision to find a problem is calculated based on the breadth of vision to find a problem in the supervisor's evaluation 12c.

The evaluation point related to the depth of awareness that is one of the minor elements of the improvement ability is calculated based on evaluation points of viewpoints related to a multifaceted analysis, an ability to find an original problem, and an accuracy of root cause identification. The evaluation point related to the multifaceted analysis is calculated based on the number of items in the category. The evaluation point related to the ability to find an original problem is calculated based on the ability to find an original problem in the supervisor's evaluation 12c. The evaluation point related to the accuracy of root cause identification is calculated based on the accuracy of root cause identification in the supervisor's evaluation 12c.

The evaluation point related to the breadth of ideas that is one of the minor elements of the improvement ability corresponding to the major element “ability to plan improvement” is calculated based on evaluation points of viewpoints related to the number of options for improvement proposal and an ability to apply previous cases or an ability of expansion to other persons. The evaluation point related to the number of options for improvement proposal is calculated based on the number of items in the tags and the number of views by the other person. The tags may include all of the problem type tag, the seven-waste tag, and the improvement method tag, or may be limited to some of the tags. As the number of items in the tags increases, the improvement is related to more viewpoints. The number of views by the other person is included in the first access information of FIG. 6. The evaluation point related to the ability to apply previous cases or the ability of expansion to other persons is calculated based on the number of utilizations by the other person. The number of utilizations by the other person is included in the first access information of FIG. 6.

The evaluation point related to the degree of added value that is one of the minor elements of the improvement ability is calculated based on evaluation points of viewpoints related to the degree of return on investment (ROI) and the degree of versatility. The evaluation point related to the degree of ROI is calculated based on the amount of effect money that is included in the improvement proposal information 12a input by the proponent. The evaluation point related to the degree of versatility is calculated based on the versatility in the supervisor's evaluation 12c and the number of favorable evaluations by the other person. The number of favorable evaluations by the other person is included in the first access information of FIG. 6.

The evaluation point related to the originality that is one of the minor elements of the improvement ability is calculated based on evaluation points of viewpoints related to a fundamental review and the degree of novelty or advancement. The evaluation point related to the fundamental review is calculated based on the originality of the idea in the supervisor's evaluation 12c. The evaluation point related to the degree of novelty or advancement is calculated based on the degree of novelty or advancement in the supervisor's evaluation 12c.

The evaluation point related to the degree of accomplishment that is one of the minor elements of the improvement ability corresponding to the major element “ability to achieve improvement” is calculated based on evaluation points of viewpoints related to an impact of improvement, a speed of improvement, and utilization of information of other persons. The evaluation point related to the impact of improvement is calculated based on the amount of effect money that is included in the improvement proposal information 12a input by the proponent and the number of favorable evaluations by the other person. The number of favorable evaluations by the other person is included in the first access information of FIG. 6. The evaluation point related to the speed of improvement is calculated based on the completion rate included in the second access information of FIG. 6. The evaluation point related to the utilization of information of other persons is calculated based on the number of utilizations of information of the other person by the proponent. The number of utilizations of information of the other person is included in the third access information of FIG. 6.

The evaluation point related to the degree of involvement that is one of the minor elements of the improvement ability is calculated based on evaluation points of viewpoints related to involvement within a proponent's department and involvement of other departments. The evaluation point related to the involvement within a proponent's department is calculated based on the cooperation within a proponent's department in the supervisor's evaluation 12c. The evaluation point related to the involvement of other departments is calculated based on the cooperation with other departments in the supervisor's evaluation 12c.

As described above, the improvement ability calculation device 15 calculates the proponent's improvement ability based on, for example, (a) the number of submissions of the improvement proposal information 12a by the proponent, (b) the number of items in the classification associated with the improvement proposal information 12a, (c) the amount of effect money that is input to the improvement proposal information 12a, (d) the information on the access to the improvement proposal information 12a from the other person (first access information), (e) the supervisor's evaluation 12c for the improvement proposal information 12a, (f) the information on the implementation of the proponent's improvement proposal by the proponent (second access information), and (g) the information on the access to the information of the other person from the proponent (third access information).

For example, the improvement ability is evaluated while increasing the proportions of (e) the supervisor's evaluation 12c and (d) the first access information on the other person and reducing the proportions of the other elements. The fact that the other person accesses the improvement proposal information leads to a possibility that the improvement proposal information is useful to the other person, attracts attention of the other person, or arouses interest of the other person. By calculating the proponent's improvement ability based on the first access information on the other person, the proponent's improvement ability can be evaluated more appropriately because the evaluation by the other person different from the supervisor can be taken into consideration.

It is appropriate to evaluate the improvement ability based on the number of utilizations by the other person, the number of favorable evaluations by the other person, and the number of views by the other person in descending order of importance in (d) the information on the access from the other person. The proponent's improvement ability can be evaluated more appropriately because the proponent's improvement ability can be evaluated based on the degree of influence on the other person. Further, the improvement ability is evaluated in consideration of (b) the number of items in the classification, that is, the number of items in the category, the number of items in the tags, and the like. By evaluating the proponent's improvement ability more favorably as the number of items in the classification increases, the proponent's improvement ability can be evaluated more appropriately.

It is appropriate to evaluate the improvement ability favorably when (f) the information on the implementation of the proponent's improvement proposal by the proponent is present. It is particularly appropriate to evaluate the improvement ability more favorably as the completion rate increases. The fact that the solution is actually implemented is worth a favorable evaluation. Even if the implementation is not completed, the improvement ability can be evaluated more appropriately by evaluating the improvement ability based on the rate of completion.

The improvement ability is evaluated in consideration of (g) the third access information. The fact that the proponent accesses the improvement proposal information 12a of the other person may lead to such an evaluation that the proponent actively carries out an improvement activity. Thus, the proponent's improvement ability can be evaluated more appropriately in consideration of the third access information for the proponent's improvement ability.

The comment storage device 16 stores comments related to the improvement ability. For example, the comment includes description of a current improvement ability, and measures to further improve the current improvement ability. For example, the comment storage device 16 stores a comment related to the evaluation points of the major elements of the improvement ability, and also a comment related to the proportions of the major elements. The comment storage device 16 also stores a comment related to the evaluation points of the minor elements of the improvement ability, and also a comment related to the proportions of the minor elements. As the comment, the evaluation points of the viewpoints and the proportions of the viewpoints may be taken into consideration.

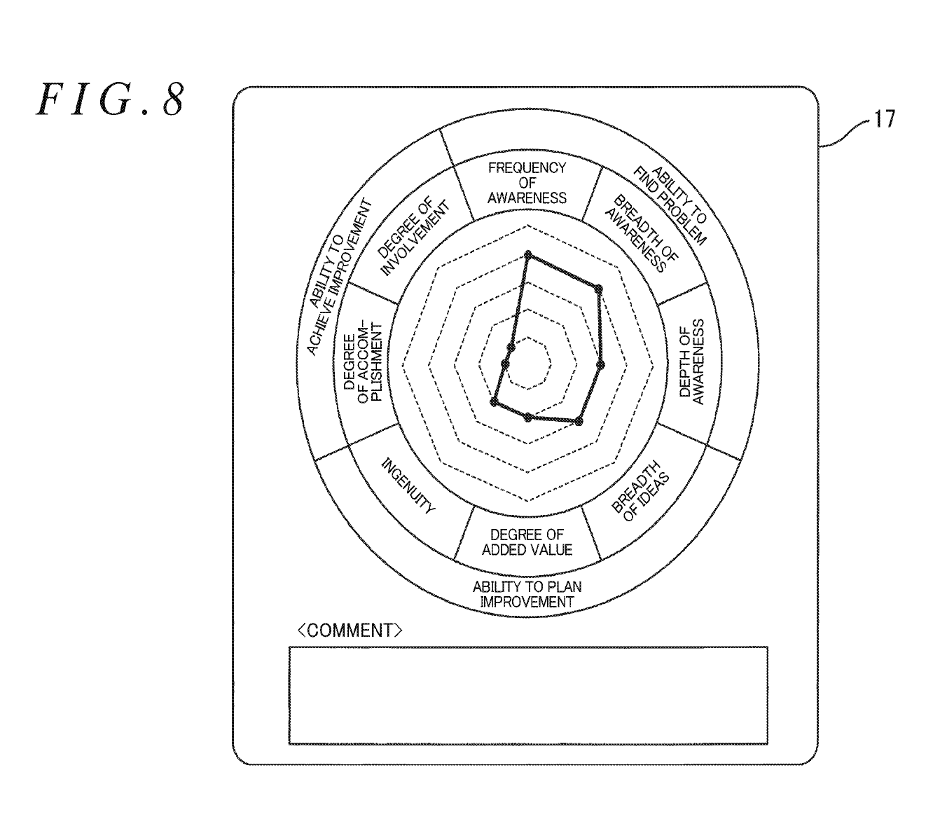

As illustrated in FIG. 8, the presentation device 17 presents the improvement ability calculated by the improvement ability calculation device 15, and the comment stored in the comment storage device 16. The presentation device 17 may display the display contents illustrated in FIG. 8 on a display screen, or may transmit data on the contents illustrated in FIG. 8 to the proponent, the supervisor, or the like. In the former case, the presentation device 17 may be, for example, a stationary terminal or a mobile terminal similarly to the input device 11 and the access device 13. In this case, an application is installed in the presentation device 17 so that the improvement ability and the comment can be presented.

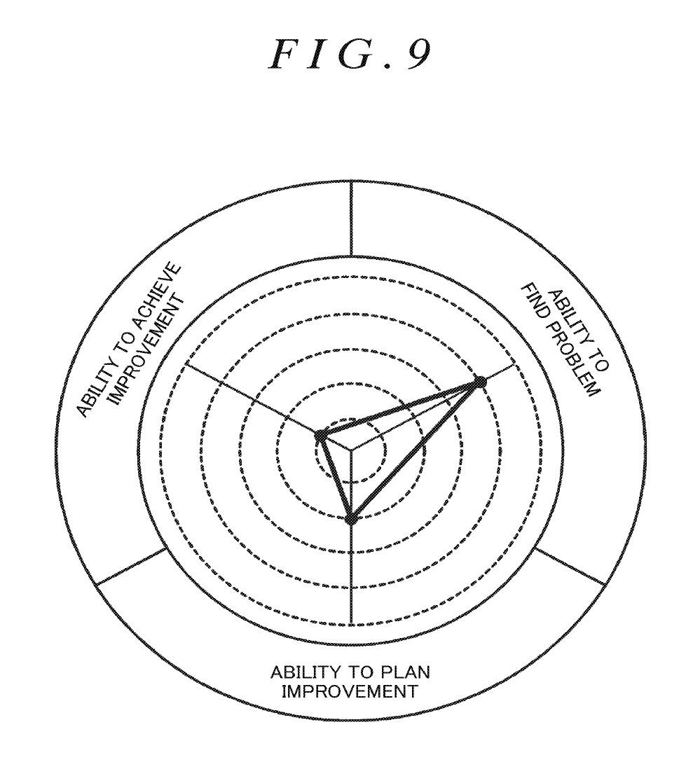

For example, as illustrated in FIG. 8, the presentation device 17 has an improvement ability presentation area as an upper stage, and a comment presentation area as a lower stage. For example, the improvement ability may be presented by a method using a radar chart. FIG. 8 illustrates a radar chart regarding the minor elements of the improvement ability. Alternatively, a radar chart regarding the major elements of the improvement ability may be presented as illustrated in FIG. 9. The radar chart illustrated in FIG. 8 and the radar chart illustrated in FIG. 9 may be presented while switching the two radar charts. The improvement ability may be presented in a format other than the radar chart, such as a table showing the evaluation points as numerals, or a bar graph.

Based on the improvement ability calculated by the improvement ability calculation device 15 and the comments stored in the comment storage device 16, a comment related to the calculated improvement ability is extracted, and the extracted comment is presented in the comment presentation area of the presentation device 17.

By presenting the improvement ability on the presentation device 17, the proponent can appropriately grasp his/her improvement ability. By presenting the comment on the presentation device 17, the proponent can grasp the meaning of his/her improvement ability more deeply, and can also grasp how the improvement activity should be carried out in the future.

What is claimed is:

1. An ability evaluation system, comprising:
an input device configured to input improvement proposal information provided by a proponent, the improvement proposal information including at least one of a problematic issue, a solution to the issue, and a method for implementing the solution to the issue;
an improvement proposal storage device configured to store the input improvement proposal information;
an access device configured to allow at least another person different from the proponent to access the improvement proposal information stored in the improvement proposal storage device;
an access information storage device configured to store first access information on the other person when the other person accesses the improvement proposal information with the access device; and
an improvement ability calculation device configured to calculate, based on the first access information, an improvement ability of the proponent who provides the improvement proposal information.

2. The ability evaluation system according to claim 1, wherein
the access device is configured to allow the other person to view the improvement proposal information,
the access information storage device is configured to store the number of views as the first access information when the other person views the improvement proposal information, and
the improvement ability calculation device is configured to calculate the improvement ability based on the number of views.

3. The ability evaluation system according to claim 1, wherein
the access device is configured to allow the other person to give a favorable evaluation for the improvement proposal information,
the access information storage device is configured to store the number of favorable evaluations as the first access information when the other person gives the favorable evaluation for the improvement proposal information, and
the improvement ability calculation device is configured to calculate the improvement ability based on the number of favorable evaluations.

4. The ability evaluation system according to claim 1, wherein
when the other person utilizes the improvement proposal information for an operation of the other person, the access information storage device is configured to store the number of utilizations by the other person as the first access information, and
the improvement ability calculation device is configured to calculate the improvement ability based on the number of utilizations.

5. The ability evaluation system according to claim 1, wherein
the access device is configured to allow the proponent and the other person to access the improvement proposal information,
when the proponent executes the method for implementing the solution to the issue, the access information storage device is configured to store information on execution by the proponent as second access information on the proponent, and
the improvement ability calculation device is configured to calculate the improvement ability based also on the second access information.

6. The ability evaluation system according to claim 1, wherein
the access device is configured to allow the proponent to access improvement proposal information of the other person,
the access information storage device is configured to store, as third access information on the proponent, the number of accesses to the improvement proposal information of the other person from the proponent, and
the improvement ability calculation device is configured to calculate the improvement ability based also on the third access information.

7. The ability evaluation system according to claim 2, wherein the improvement ability calculation device is configured to calculate at least one of an ability to find a problem and an ability to plan improvement as the improvement ability based on the number of views.

8. The ability evaluation system according to claim 3, wherein the improvement ability calculation device is configured to calculate at least one of an ability to plan improvement and an ability to achieve improvement as the improvement ability based on the number of favorable evaluations.

9. The ability evaluation system according to claim 4, wherein the improvement ability calculation device is configured to calculate an ability to plan improvement as the improvement ability based on the number of utilizations.

10. The ability evaluation system according to claim 5, wherein the improvement ability calculation device is configured to calculate an ability to achieve improvement as the improvement ability based on the information on execution that is the second access information.

11. The ability evaluation system according to claim 6, wherein the improvement ability calculation device is configured to calculate an ability to achieve improvement as the improvement ability based on the number of accesses from the proponent that is the third access information.

12. The ability evaluation system according to claim 1, wherein
the input device is further configured to input a supervisor's evaluation that is provided by a supervisor for the improvement proposal information,
the improvement proposal storage device is further configured to store the supervisor's evaluation in association with the improvement proposal information, and
the improvement ability calculation device is configured to calculate the improvement ability based on the supervisor's evaluation.

13. The ability evaluation system according to claim 12, wherein the supervisor's evaluation is an evaluation related to at least one of a willingness to find a problem, a breadth of vision to find a problem, an ability to find an original problem, an accuracy of root cause identification, versatility, originality of an idea, a degree of novelty or advancement, cooperation within a department to which the proponent belongs, and cooperation with another department.

14. The ability evaluation system according to claim 1, wherein
when the improvement proposal information is classified from a plurality of viewpoints, the input device is further configured to input a corresponding classification,
the improvement proposal storage device is further configured to store the classification in association with the improvement proposal information, and
the improvement ability calculation device is configured to calculate the improvement ability based on the number of corresponding classifications stored in the improvement proposal storage device.

15. The ability evaluation system according to claim 1, further comprising:
a comment storage device configured to store a comment related to the improvement ability; and
a presentation device configured to present the comment related to the calculated improvement ability based on the calculated improvement ability and the comment stored in the comment storage device.
